(19) United States
(12) Patent Application Publication
(10) Pub. No.: US 2025/0273385 A1
(43) Pub. Date: Aug. 28, 2025

(54) PLANAR TRANSFORMER FOR DC/DC CONVERTER

(71) Applicant: EnerSys Delaware Inc., Reading, PA (US)

(72) Inventors: Lingeshwaren SOBRAYEN, Arras (FR); Brahim AZZABI ZOURAQ, Arras (FR); Patrick DEHEM, Arras (FR)

(21) Appl. No.: 19/049,829

(22) Filed: Feb. 10, 2025

(30) Foreign Application Priority Data
Feb. 23, 2024 (EP) 24305296.6

(51) Int. Cl. H01F 27/28; H01F 27/34; H02M 1/00; H02M 3/00

(52) U.S. Cl. CPC H01F 27/2804; H01F 27/34; H02M 1/0064; H02M 3/01; H01F 2027/2809; H01F 2027/2819

(57) ABSTRACT

A planar electrical transformer for a DC/DC converter comprises first and second stacked structures. Each stacked structure comprises a set of primary winding layers comprising first and second pairs of layers, and a set of secondary winding layers comprising first and second pairs of layers. The set of secondary winding layers is arranged between the first pair of layers of the set of primary winding layers and the second pair of layers of the set of primary winding layers. The first stacked structure and the second stacked structure are arranged such that a layer of the set of primary winding layers of the first structure faces a layer of the set of primary winding layers of the second structure across an air gap.

### RELATED APPLICATION

This application claims priority from European Patent Application No. 24305296.6, filed on Feb. 23, 2024, the contents of which are incorporated herein by reference in its entirety.

### TECHNICAL FIELD

The present disclosure relates to a planar electrical transformer. Particularly, but not exclusively, the present disclosure relates to a planar transformer in a DC/DC converter. The present disclosure also relates to methods of manufacturing a planar transformer for a DC/DC converter.

### BACKGROUND

Direct current to direct current, DC/DC, converters are a type of power converter used in a variety of applications to convert a source of direct current from one voltage level to another voltage level. DC/DC converters may be used in the charging of electrical vehicles, or wireless power transfer systems, for example. DC/DC converters typically include electrical transformers to match voltage levels and ensure galvanic isolation.

High frequency operation (e.g. greater than 500 kHz) allows the transformer core size to be reduced and the overall converter power density to be increased. Planar transformer technology may be well adapted for such frequency levels, owing to better thermal dissipation, controlled parasitics and manufacturing repeatability. Planar transformers may comprise stacked structures formed of multiple layers of primary and secondary windings. A winding may comprise thin copper sheets riveted together, or may be etched onto a printed circuit board, PCB, for example. Such planar structures also enable the transformer to be relatively flat, compact and structurally robust, and thereby particularly (though not exclusively) suitable for use on board an electrically powered vehicle, e.g. coupled to or within a battery pack for the vehicle.

However, two main issues need to be addressed to ensure good performance at high frequency. The first issue is the proximity effect between conducting copper layers: this increases the alternating current, AC, resistance (R_{ac}) of the windings and can induce thermal stress if not controlled. The second issue is parasitic capacitances: this concerns mainly inter-winding capacitances that exist between layer turns of different windings. These two issues may form a trade-off, wherein one may be addressed but at the expense of the other.

The present disclosure seeks to address the above-mentioned problems. Alternatively or additionally, the present disclosure seeks to provide improved electrical transformers and/or DC/DC converters.

### SUMMARY

According to a first aspect, there is provided a planar transformer for a direct current to direct current, DC/DC, converter, the planar transformer comprising: a first portion; and a second portion, wherein each of the first and the second portion comprises a stacked structure comprising: a first set of layers comprising first and second pairs of layers; and a second set of layers comprising first and second pairs of layers, wherein one of the first set and the second set is a set of primary winding layers, and the other one of the first set and the second set is a set of secondary winding layers, wherein the second set is arranged between the first pair of layers of the first set and the second pair of layers of the first set, and wherein each layer of the first and second sets is electrically isolated from every other layer of the first and second sets; and wherein the first portion and the second portion are arranged such that a layer of the first set of layers of the first portion faces a layer of the first set of layers of the second portion across an air gap.

In embodiments, the first portion comprises a first printed circuit board, PCB, and the second portion comprises a second PCB.

In embodiments, the first portion and the second portion comprise an identical arrangement of layers to one another.

In embodiments, for each of the first and second portions, the first set of layers and/or the second set of layers comprises a transposed layer formed of at least two segments of different conductors.

In embodiments, for each of the first and second portions, each layer of the first set of layers and/or each layer of the second set of layers comprises a transposed layer formed of at least two segments of different conductors.

In embodiments, for each of the first and second portions: the first set of layers is the set of primary winding layers; the second set of layers is the set of secondary winding layers; each layer of the second set of layers comprises a transposed layer formed of at least two segments of different conductors; and the first set of layers does not comprise a transposed layer formed of at least two segments of different conductors.

In embodiments, the or each transposed layer comprises a planar Litz structure.

In embodiments, each of the first and second portions comprises a first primary winding and a second primary winding connected in parallel to the first primary winding, each of the first and second primary windings comprising a respective plurality of layers of the set of primary winding layers.

In embodiments, for each of the first and second portions, layers of the first primary winding are interleaved with layers of the second primary winding.

In embodiments, for each of the first and second portions, at least some of the primary layers in the set of primary layers are connected to one another in series.

In embodiments, for each of the first and second portions, at least some of the secondary layers in the set of secondary layers are connected to one another in parallel.

In embodiments, a layer of the first set of layers of the first portion is connected to a layer of the first set of layers of the second portion.

In embodiments, the planar transformer and/or the DC/DC converter is configured to operate with a switching frequency of at least 1 megahertz.

According to a second aspect, there is provided planar electrical transformer comprising: a first printed circuit board, PCB; and a second PCB, wherein each of the first PCB and the second PCB comprises a stacked structure comprising: first and second pairs of primary layers; and first and second pairs of secondary layers, wherein the first and second pairs of secondary layers are arranged between the first pair of primary layers and the second pair of primary layers, and wherein the first PCB and the second PCB are arranged such that a primary layer of the first PCB faces a primary layer of the second PCB across an air gap.

According to a third aspect, there is provided a method of manufacturing a planar electrical transformer for a direct current to direct current, DC/DC, converter, the method comprising: providing a first stacked structure and a second stacked structure, each of the first and second stacked structures comprising: a first set of layers comprising first and second pairs of layers; and a second set of layers comprising first and second pairs of layers, wherein one of the first set and the second set is a set of primary winding layers, and the other one of the first set and the second set is a set of secondary winding layers, wherein the second set is arranged between the first pair of layers of the first set and the second pair of layers of the first set, and wherein each layer of the first and second sets is electrically isolated from every other layer of the first and second sets; and arranging the first and second stacked structures such that a layer of the first set of layers of the first stacked structure faces a layer of the first set of layers of the second stacked structure across an air gap.

It should be appreciated that features described in relation to one aspect of the present disclosure may be incorporated into other aspects of the present disclosure. For example, a method aspect may incorporate any of the features described with reference to an apparatus aspect and vice versa.

### DESCRIPTION OF THE DRAWINGS

Embodiments of the present disclosure will now be described by way of example only with reference to the accompanying schematic drawings of which:

FIG. 1 shows a planar electrical transformer;

FIG. 2 shows a planar electrical transformer according to embodiments of the present disclosure;

FIG. 3 shows a planar electrical transformer according to embodiments of the present disclosure;

FIG. 4 shows a planar electrical transformer according to embodiments of the present disclosure;

FIG. 5 shows a planar electrical transformer;

FIG. 6 shows a planar electrical transformer according to embodiments of the present disclosure;

FIG. 7 shows a circuit diagram of an LLC resonant converter comprising an electrical transformer according to embodiments of the present disclosure;

FIGS. 8a and 8b are experimental waveforms for an LLC resonant converter at full load, according to embodiments of the present disclosure;

FIGS. 9a and 9b are experimental waveforms for an LLC resonant converter at zero load, according to embodiments of the present disclosure; and

FIG. 10 shows a flow diagram depicting a method of manufacturing an electrical transformer according to embodiments of the present disclosure.

### DETAILED DESCRIPTION

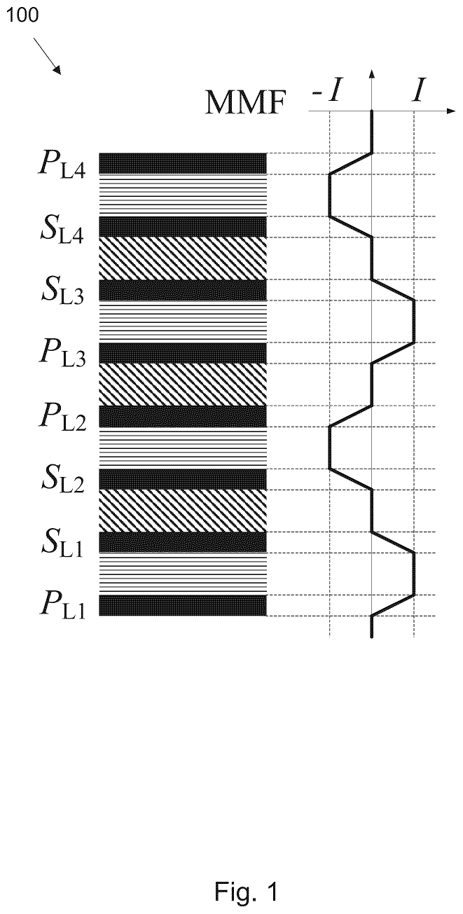

Referring to FIG. 1, there is shown schematically a planar electrical transformer 100 having a stacked structure, and in particular the winding stackup for the transformer. A transformer may comprise two magnetic core halves and a winding stackup. The magnetic core components are omitted from FIG. 1 for brevity. The stacked structure is formed on a PCB, e.g. by etching layers onto the PCB. The stacked structure shown in FIG. 1 may be referred to as having a “paired layer interleaving” configuration. Layers of the same winding are grouped into pairs, except for the first and last layer of the winding. The grouped pairs are then interleaved. This results in a layered structure of the type P_{L1}-S_{L1}-S_{L2}-P_{L2}-P_{L3}-S_{L3}-S_{LA}-P_{LA}, as shown in FIG. 1, where P_{Ln} refers to the nth layer of primary winding and Sun refers to the nth layer of secondary winding. That is, S_{L1} is paired with S_{L2}, P_{L2} is paired with P_{L3}, etc. Each layer may have a thickness of around 105 microns (μm), although it will be understood that different layer thicknesses may be used for some or all of the layers in other examples.

This configuration provides a bipolar distribution of magnetomotive force, MMF. This is shown on the right hand side of FIG. 1. The proximity effect between conducting copper layers increases the AC resistance of the windings and can induce thermal stress if not controlled. Limiting the MMF amplitude through the stacked structure is a way of reducing the proximity effect, i.e. reducing R_{ac}. In the arrangement shown in FIG. 1, the amper-turns for each layer are equal to I, the MMF maximum value is then limited to I, and this allows R_{ac} to be reduced. Moreover, the arrangement shown in FIG. 1 has a reduced number of primary/secondary interfaces, since layers of the same winding are grouped into pairs and then the pairs are interleaved. Limiting the number of primary/secondary interfaces reduces the parasitic capacitance of the transformer 100. Therefore, the arrangement shown in FIG. 1 can address the trade-off between R_{ac} and parasitic capacitance.

However, the transformer 100 (i.e. the winding stackup) shown in FIG. 1 may be limited to handling relatively low currents. For handling higher currents, a second identical PCB would generally be used in parallel with the first PCB, within the same transformer core. In this case, the benefits of the paired interleaving configuration are undermined, at least as far as parasitic capacitance is concerned. Indeed, paralleling two PCBs doubles the number of primary/secondary interfaces and hence the parasitic capacitance resulting therefrom.

Embodiments of the present disclosure provide an electrical transformer which can handle high currents and high frequencies, whilst reducing both parasitic capacitance and R_{ac}, compared to known transformers. Moreover, embodiments of the present disclosure provide an electrical transformer which has a reduced manufacturing complexity compared to known transformers.

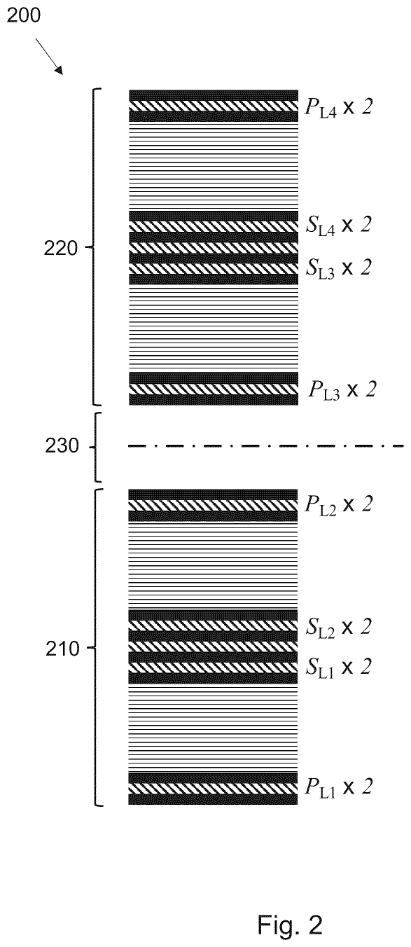

Referring to FIG. 2, there is shown schematically an electrical transformer 200 according to embodiments of the present disclosure, and in particular the winding stackup for the transformer. The transformer 200 comprises two portions 210, 220 each comprising a respective stacked structure. The two portions 210, 220 are separated by an air gap 230. In embodiments, each portion 210, 220 is formed of a respective PCB. Each stacked structure has a plurality of layers. Some or all of the layers may be substantially planar such that the layers and/or PCBs can be stacked in a mechanically stable, spatially efficient and compact manner.

Compared to the transformer 100 shown in FIG. 1, the windings of the transformer 200 shown in FIG. 2 are divided into two groups and distributed over two PCBs. The first PCB 210 on the lower core half houses P_{L1}-S_{L1}-S_{L2}-P_{L2}, whereas the second PCB 220 on the upper core half contains P_{L3}-S_{L3}-S_{L4}-P_{LA}, where Pin refers to the nth primary winding layer and Sun refers to the nth secondary winding layer. Then, in order to obtain the same overall copper cross-section as two PCBs of the configuration shown in FIG. 1 arranged in parallel, each layer is duplicated. That is, a given layer is duplicated to obtain a given pair of layers. For example, ‘P_{L1}×2’ in FIG. 2 refers to a pair of primary winding layers, corresponding to a duplication of the P_{L1} primary winding layer. Thus, a single layer having a thickness of, for example, 105 μm, is replaced with a pair of layers each having a thickness of, for example, 105 μm.

As a result, each PCB 210, 220 of the transformer 200 comprises first and second pairs of primary winding layers and first and second pairs of secondary winding layers, where the secondary winding layers are arranged between the first pair of primary winding layers and the second pair of primary winding layers. It will be understood, however, that in alternative embodiments the primary winding layers and the secondary winding layers may be switched in one or both of the PCBs 210, 220, such that the primary winding layers are arranged between the first pair of secondary winding layers and the second pair of secondary winding layers. The two PCBs 210, 220 are arranged such that a primary winding layer of the first PCB 210 faces a primary winding layer of the second PCB 220 across an air gap 230. In embodiments where the primary winding layers and the secondary winding layers are switched, a secondary winding layer of the first PCB 210 may face a secondary winding layer of the second PCB 220 across the air gap 230.

As such, the arrangement shown in FIG. 2 maintains a total of four primary/secondary interfaces, which is the same as for the transformer 100 shown in FIG. 1, but with an effective copper section that would otherwise have required eight primary/secondary interfaces (i.e. by paralleling two PCBs of the type shown in FIG. 1). This provides a reduction in parasitic capacitance whilst enabling the transformer 200 to handle higher currents than the transformer 100 shown in FIG. 1. Moreover, the arrangement shown in FIG. 2 allows the thickness of these four primary/secondary interfaces to be doubled (or more than doubled) on the same PCBs, thereby reducing static interwinding capacitance further by 50%. For example, the thickness of each primary/secondary interface may be at least 930 μm, compared to at least 430 μm in the arrangement shown in FIG. 1 for the same PCB thickness of 3.2 mm. Further, the first PCB 210 and the second PCB 220 comprise an identical arrangement of layers to one another. This reduces manufacturing complexity, since the second PCB 220 is the same as the first PCB 210. This is less complex and/or costly to manufacture compared to a case in which the two PCBs are different and/or have different arrangements of layers.

For each of the first and second PCBs 210, 220, each primary and secondary winding layer is electrically isolated from every other primary and secondary winding layer. Separation between layers is shown with hatching in FIG. 2, with horizontal hatching showing interfaces between primary and secondary layers, and diagonal hatching showing interfaces between pairs of primary layers and between pairs of secondary layers. Polymer layers (not shown) may be used to electrically isolate each layer. An example of such a polymer is polyimide, which may be applied as a film. In some embodiments, Kapton™ is used as the polymer layer. Polyimide film may be relatively thin and/or light compared to some other insulators (thereby allowing the transformer 200 to be relatively flat and compact). Additionally or alternatively, polyimide film may be stable over a wider range of temperatures compared to some other insulators. Conducting layers may be electrically isolated from other conducting layers in other ways, for example using other dielectrics or insulators, in alternative embodiments.

In embodiments, each of the first and second PCBs 210, 220 comprises a respective ferrite core. For example, an E43/10/28 core may be used for each PCB 210, 220, it being understood that different types of core may be used in other embodiments. The transformer 200 may comprise more, fewer and/or different components than those shown in FIG. 2 in alternative embodiments. For example, the transformer 200 may comprise one or more output connectors for connecting to a transformer output, and/or one or more input connectors for connecting to a transformer input. Additionally or alternatively, the transformer 200 may comprise one or more casing structures for protecting the internal componentry of the transformer 200 from environmental conditions such as moisture, and/or one or more PCB maintaining structures or potting agents for maintaining the positions of the PCBs 210, 220 or other componentry within the transformer 200 and/or for maintaining the air gap 230 between the PCBs 210, 220.

The arrangement shown in FIG. 2 thus provides an improvement over the arrangement shown in FIG. 1. At high frequencies, however, the arrangement shown in FIG. 2 may encounter a limitation in terms of unequal current sharing. The duplication of layers to provide an increased copper section may be almost equivalent to using a copper thickness twice as great (e.g. 210 μm instead of 105 μm) for a single layer. When skin depth is very low (e.g. at high frequency), the current densities can reach higher values.

To address potential unequal current sharing of duplicated layers, the principle of Litz wire construction may be applied. In other words, instead of each conductor running as a solid copper track from start to finish on the same layer, they are divided into segments undulating between layers. That is, each layer may comprise a transposed layer formed of at least two discrete segments of different conductors. PCBs provide the possibility of realising these layer transpositions conveniently by means of through holes, or blind or buried vias.

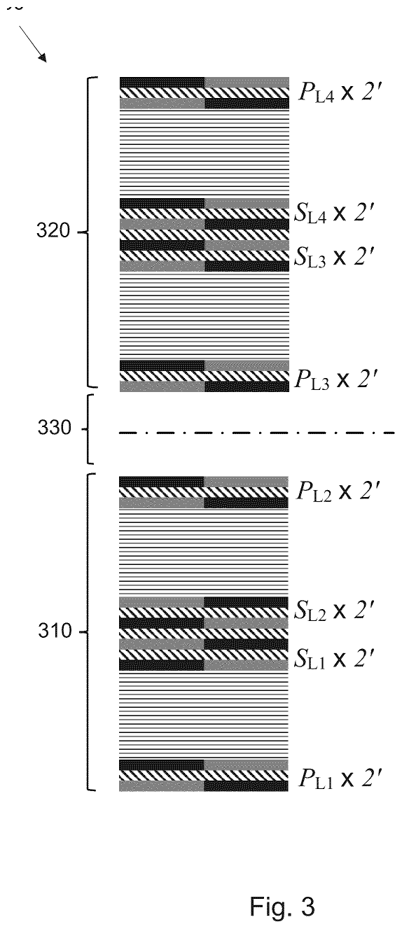

An example of such a configuration is shown in FIG. 3, which depicts an electrical transformer 300 according to embodiments. Some elements of the transformer 300 are similar to elements described with reference to the transformer 200 shown in FIG. 2. Corresponding reference numerals, incremented by 100, are used for similar items.

The embodiments shown in FIG. 3 combine the concept introduced with reference to FIG. 2 (i.e. splitting a stack between two PCBs and duplicating layers) with a planar Litz concept, in a single design. This has the benefit of reducing both R_{ac} and parasitic capacitances, as well as providing more equal current sharing. In the arrangement shown in FIG. 3, Litz-type transpositions are used in both primary and secondary layers of each PCB 310, 320. That is, every layer of the transformer 300 comprises a transposed layer formed of at least two segments of different conductors. This reduces unequal current sharing of duplicated layers.

In the embodiments shown in FIG. 3, each transposed layer is formed of two segments of different conductors. In other embodiments, each transposed layer is formed of more than two segments of different conductors. The number of transpositions (also referred to as ‘permutations’ or ‘undulations’) across one layer and/or revolution may be selected based on a number of factors. A higher number tends to ensure better current distribution, but may also increase the complexity of production due to additional resistances introduced by vias and track cut-outs for every undulation. If overdone, the technique could be counterproductive and even increase the overall AC resistance of the transposed layers. Therefore, there may be a trade-off between production complexity and current distribution.

The arrangement shown in FIG. 3 a priori involves layer transpositions both in the primary and secondary duplicated winding layers to ensure current sharing. A potential drawback of this is construction and mounting complexity. In this context, it may be beneficial to use a configuration that at least partially suppresses the transposition operations in the primary side whilst keeping the same or similar current sharing. This may be achieved by exploiting the symmetry that exists along the air gap 330 between the first and second PCBs 310, 320.

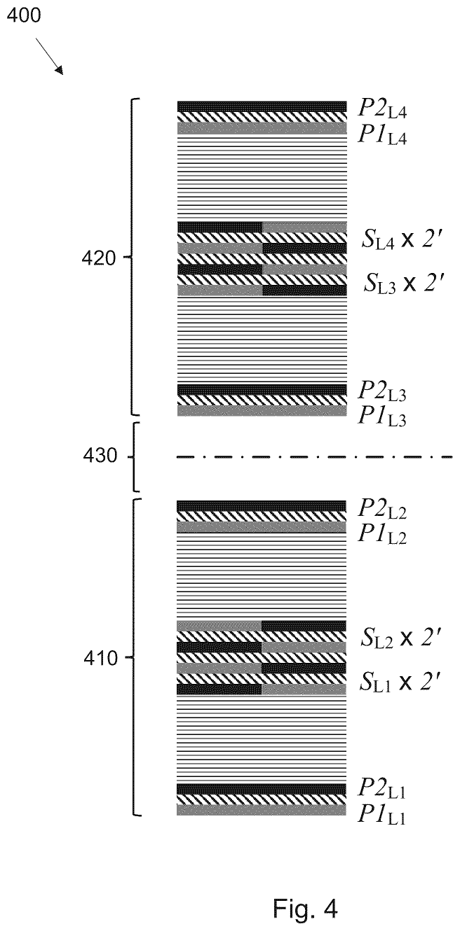

Such a configuration is shown in FIG. 4, which depicts an electrical transformer 400 according to embodiments. Some elements of the transformer 400 are similar to elements described with reference to the transformer 300 shown in FIG. 3. Corresponding reference numerals, incremented by 100, are used for similar items.

The transformer 400 shown in FIG. 4 maintains the split PCB structure with Litz-type transpositions of the transformer 300 shown in FIG. 3. However, for the primary windings, transposed layers are replaced with winding parallelisation without layer transpositions. For example, P_{L1}×2 in the transformer 300 of FIG. 3 is converted to P1_{L1}-P2_{L1} in the transformer 400 of FIG. 4, where P1 and P2 are different primary windings connected in parallel. As such, the secondary winding layers comprise transposed layers formed of multiple segments of different conductors, whereas the primary winding layers do not comprise transposed layers formed of multiple segments of different conductors. Instead, each primary winding layer comprises a single uninterrupted conductor across the layer.

In the embodiments shown in FIG. 4, the respective layers of the two parallel primary windings P1, P2 are interleaved, i.e. disposed in alternating fashion. This provides a more equal current distribution between the two primary windings. In particular, this ensures that each primary winding has one layer facing the air gap 430, namely P2_{L2} and P1_{L3}, rather than a single primary winding having two layers facing the air gap 430. A result of this is that the opposition caused by the exposed layer of the first primary winding P1 to the air gap flux, the induced currents in the exposed layer and the resulting current distributions in the remaining layers of that winding will be identical to the second primary winding P2, by virtue of the symmetry imposed. This ensures a more equal current distribution between the two primary windings.

In addition to improved current sharing, the embodiments shown in FIG. 4 facilitate the routing of the PCBs 410, 420 with regards to the number of vias required, their placement, and the intricate track shapes and clearances needed to avoid them. These vias may be implemented as blind vias instead of through hole vias since layer undulations may occur at a half-turn position. Additional AC resistances of the vias concentrated in the same zone causes a risk of hot spot formation. In the embodiments of FIG. 4, only secondary layers involve vias, and these can be more easily arranged in a single layer turn having a relatively large track width (unlike the primary layers, which may each comprise multiple turns and thus have a narrower track width).

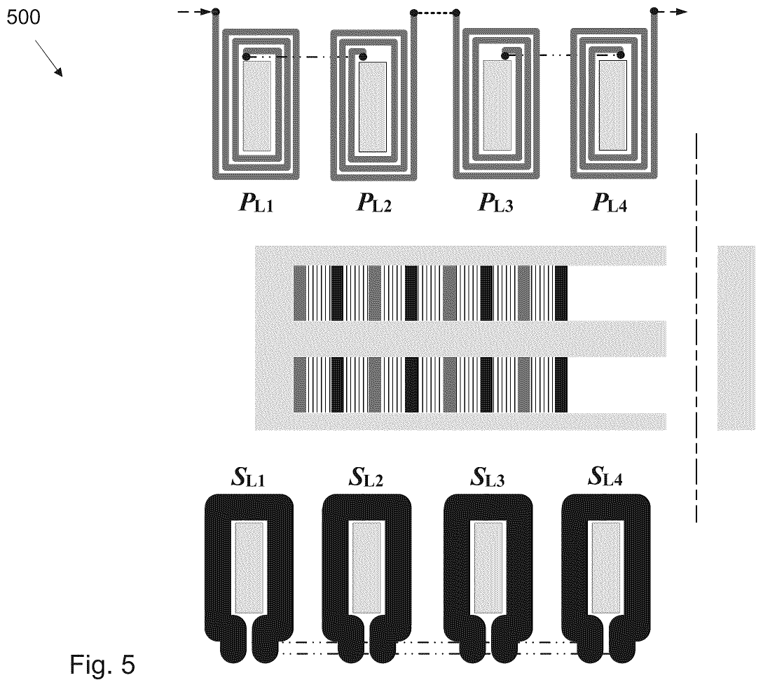

FIG. 5 shows schematically an exploded view of a known electrical transformer 500. The transformer 500 comprises a stack of layers arranged on a PCB. Interconnections between layers are depicted with dashed lines. FIG. 5 shows a ‘full interleaving’ concept, in which primary winding layers are fully interleaved with secondary winding layers. The transformer 500 shown in FIG. 5 is a 12:1 transformer. The primary side comprises four layers series connected to implement twelve turns. The secondary side comprises four layers parallel connected to implement one turn.

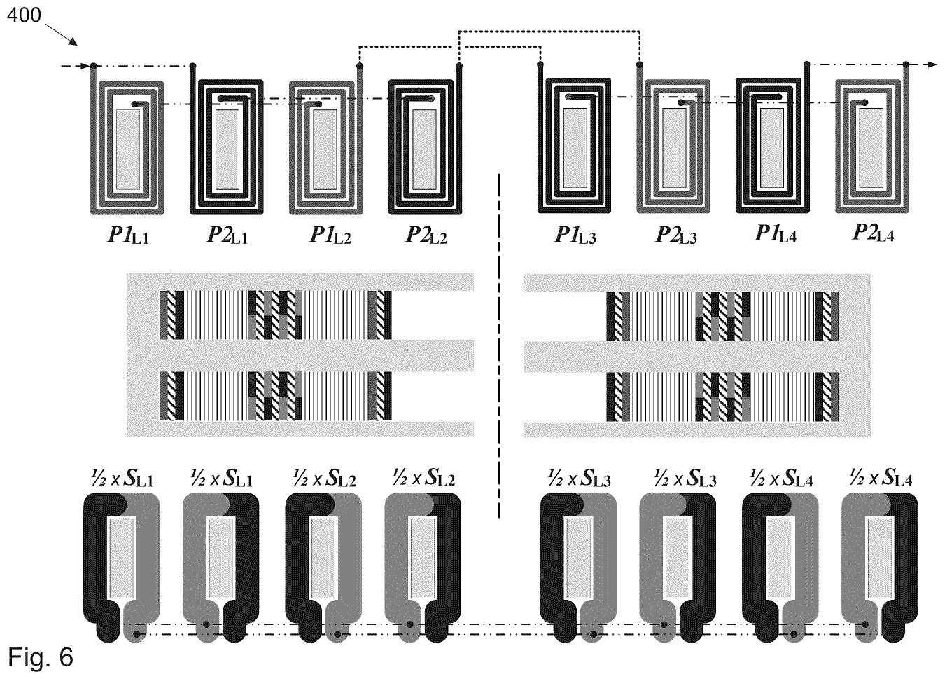

FIG. 6 shows schematically an exploded view of the electrical transformer 400, according to embodiments of the present disclosure. The transformer 400 shown in FIG. 6 is a 12:1 transformer. It will be understood that the transformer 400 may comprise different numbers of turns and/or different turns ratios in alternative embodiments.

From a manufacturing and assembly cost point of view, it is advantageous to construct the transformer 400 with two identical PCBs. While the parallel connection of single-turn secondary layers may be relatively convenient when two identical PCBs are placed on top of each other, implementing series-connected turns between identical PCBs may not be straightforward with regards to the interconnection points between the PCBs and connections to the outside. FIG. 6 illustrates an example of how this may be achieved, by ensuring a symmetry in the track routing and a particular placement of vias and interconnects. Starting with one PCB resting on the bottom core half, and flipping a second, identical, PCB, provides the required in-line interconnection points to pursue the remaining series-connected turns of the primaries on the upper core half.

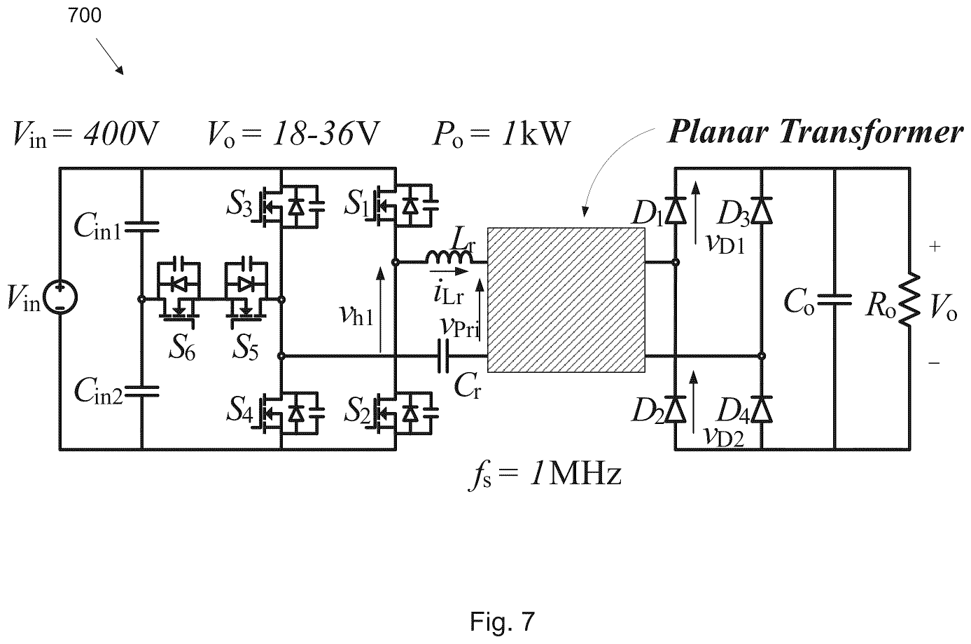

To test and compare the transformers shown in FIGS. 5 and 6, each transformer was integrated into an LLC resonant converter, and performance at both full load and no load was measured and compared. An LLC resonant converter is a type of DC/DC power converter. An electrical circuit diagram of the LLC resonant converter 700 used in the experiments is shown in FIG. 7.

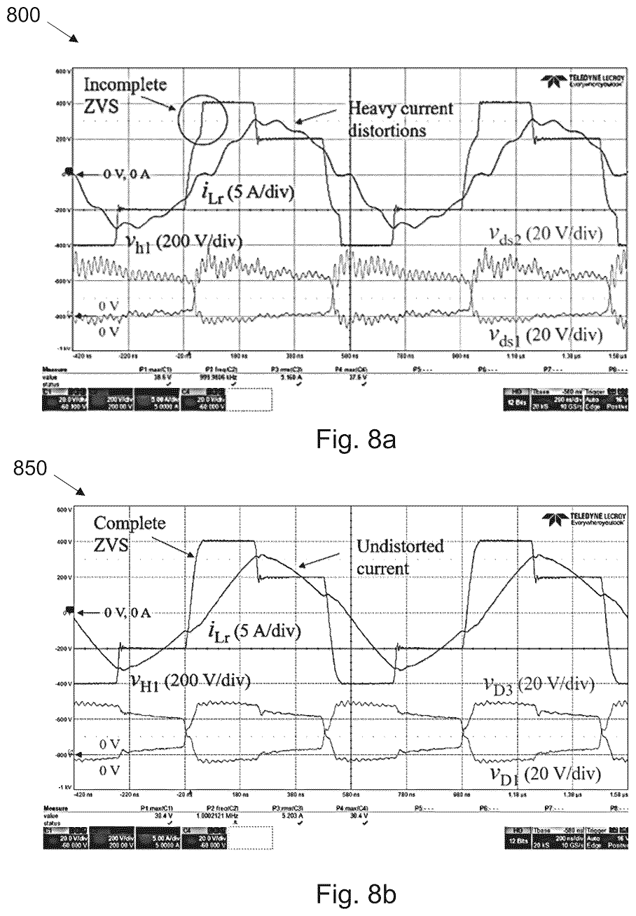

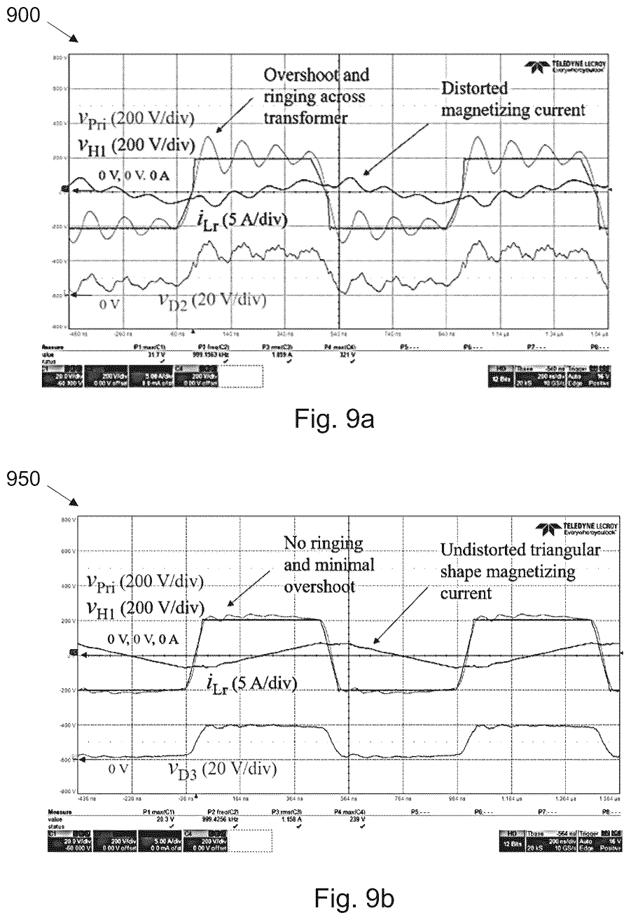

FIG. 8a shows experimental waveforms 800 at full load for the transformer 500 depicted in FIG. 5, i.e. the fully interleaved planar transformer 500, integrated into the LLC resonant converter 700 shown in FIG. 7. FIG. 8b shows the equivalent waveforms 850 (at full load) for the transformer 400 described with reference to FIGS. 4 and 6. FIG. 9a shows experimental waveforms 900 at no load for the transformer 500 depicted in FIG. 5, and FIG. 9b shows the equivalent waveforms 950 (at no load) for the transformer 400 described with reference to FIGS. 4 and 6.

As it can be seen in FIGS. 8 and 9, the waveforms 850 for the transformer 400 of the presently-disclosed embodiments at full-load (FIG. 8b) are more smooth and free of distortion than the waveforms 800 for the known transformer 500 (FIG. 8a). At no-load, waveforms 950 are still undistorted for the disclosed embodiments, with the triangular waveshape of the magnetizing current more clearly discernible (FIG. 9b) than for the known transformer 500 (FIG. 9a). Compared to the experimental waveforms 800, 900 of the full interleaved planar transformer 500 (FIGS. 8a and 9a), a significant improvement is achieved in the quality of the waveforms 850, 950 of the power converter 700 both at full-load and at no-load.

The embodiments described herein provide a planar transformer capable of overcoming both proximity losses and parasitic capacitance issues for high frequency operation (e.g. MHz level) while ensuring manufacturing simplicity. The disclosed stacked structures involve a reduction of vias in the PCBs, which reduces the risks of hot spot formation. Known systems do not address the trade-off between proximity losses and parasitic capacitance whilst maintaining manufacturing simplicity, especially at the MHz-kW level. In some known systems, for example, the parasitic capacitance of a planar transformer may be lowered, but the working range of such transformers is limited to low frequencies (e.g. up to 200 kHz) wherein the proximity losses are mild. Other known systems focus on reducing proximity effect issues without addressing the parasitic capacitance issue. For high frequency applications (e.g. up to or even beyond 1 MHZ) in the kW range, neither of these two issues (proximity effect and parasitic capacitance) can be neglected. Known systems do not address the trade-off of these issues for high frequency applications.

However, the presently disclosed embodiments are not limited to high frequencies. The transformers disclosed herein may be integrated into DC/DC converters with classical frequency values (e.g. 100-200 kHz) without additional cost, to achieve higher efficiency.

Embodiments described herein provide a novel winding stack solution for high frequency (e.g. MHz)-high power (e.g. kW) planar transformers for DC/DC power electronics converters. The simplicity of the PCB winding fabrication (e.g. reduction of the number of vias), and assembly process (e.g. through use of two identical PCBs) results in a low-cost solution suited for mass production. In comparison to conventional wound-wire transformers, the embodiments disclosed herein provide better thermal performance and control of parasitic elements whilst reducing parasitic capacitance levels.

In embodiments, the transformers 200, 300, 400 disclosed herein may be used in a wireless power transfer system. For example, the transformers 200, 300, 400 may be used on the secondary side of a WPT system. In embodiments, the transformers 200, 300, 400 can be used in a battery pack equipment for an electrically powered vehicle. Such a battery pack equipment may comprise at least one rechargeable battery. Such a battery pack equipment may be configured to be arranged within the electrically powered vehicle during charging of the battery, or may be configured to be arranged separately from the vehicle during charging of the battery. The transformers 200, 300, 400 may be used in other applications and/or environments in alternative embodiments.

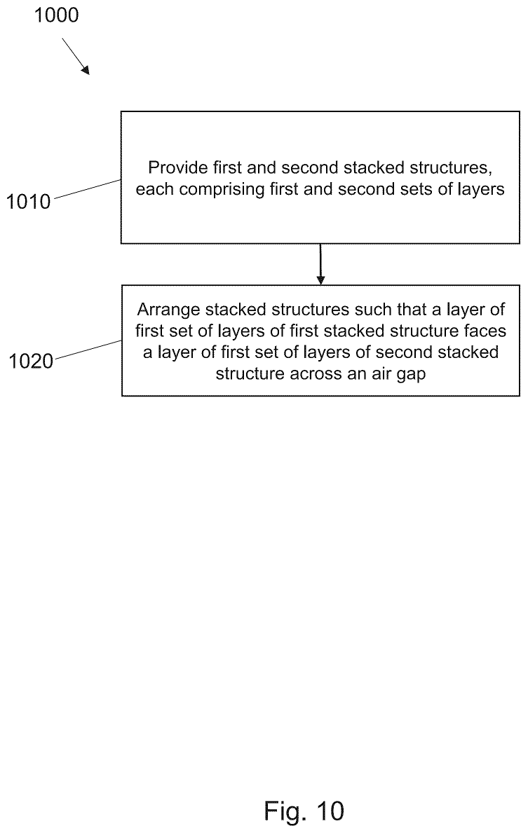

Referring to FIG. 10, there is shown a method 1000 of manufacturing a planar electrical transformer according to embodiments of the present disclosure. The planar electrical transformer is suitable for a DC/DC converter, but may additionally or alternatively be used in other systems and/or environments. The method 1000 may be used to manufacture the one of the planar transformers 200, 300, 400 described above.

At item 1010, a first stacked structure and a second structure are provided. The stacked structures may be substantially planar, and therefore readily stackable on top of (or adjacent to) one another. Each of the first and second structures comprises a first set of layers comprising first and second pairs of layers, and a second set of layers comprising first and second pairs of layers. One of the first set and the second set is a set of primary winding layers, and the other one of the first set and the second set is a set of secondary winding layers. The second set is arranged between the first pair of layers of the first set and the second pair of layers of the first set. Each layer of the first and second sets is electrically isolated from every other layer of the first and second sets.

At item 1020, the first and second stacked structures are arranged such that a layer of the first set of layers of the first stacked structure faces a layer of the first set of layers of the second stacked structure across an air gap.

Whilst the present disclosure has been described and illustrated with reference to particular embodiments, it will be appreciated by those of ordinary skill in the art that the present disclosure lends itself to many different variations not specifically illustrated herein. By way of example only, certain possible variations will now be described.

In embodiments, the planar transformers 200, 300, 400 are for use in (or comprised in) a DC/DC converter. The planar transformers 200, 300, 400 disclosed herein may however be used in other systems and/or applications in alternative embodiments. As such, a DC/DC converter may be omitted in some embodiments.

In embodiments, the first portion comprises a first printed circuit board, PCB, and the second portion comprises a second PCB. In alternative embodiments, the first and second portions comprise structures other than PCBs. For example, the structures may comprise stacks of busbars and/or wires.

In embodiments, the first portion and the second portion comprise an identical arrangement of layers to one another. In alternative embodiments, the first portion and the second portion comprise different arrangements of layers to one another.

In embodiments, for each of the first and second portions, the first set of layers and/or the second set of layers comprises a transposed layer formed of at least two segments of different conductors. In alternative embodiments, neither of the first and second sets of layers comprises a transposed layer.

In embodiments, for each of the first and second portions, each layer of the first set of layers and/or each layer of the second set of layers comprises a transposed layer formed of at least two segments of different conductors. In alternative embodiments, only a portion of the first set of layers and/or a portion of the second set of layers comprises a transposed layer.

In embodiments, for each of the first and second portions: the first set of layers is the set of primary winding layers; the second set of layers is the set of secondary winding layers; each layer of the second set of layers comprises a transposed layer formed of at least two segments of different conductors; and the first set of layers does not comprise a transposed layer formed of at least two segments of different conductors. In alternative embodiments, the first set of layers is the set of secondary winding layers and the second set of layers is the set of primary winding layers. In alternative embodiments, each layer of the set of primary winding layers comprises a transposed layer, whereas the set of secondary winding layers does not comprise a transposed layer.

In embodiments, for each of the first and second portions, layers of the first primary winding are interleaved with layers of the second primary winding. In alternative embodiments, layers of the first primary winding are not interleaved with layers of the second primary winding.

In embodiments, the planar transformer and/or the DC/DC converter is configured to operate with a switching frequency of at least 1 megahertz. In alternative embodiments, the planar transformer and/or the DC/DC converter is configured to operate with lower switching frequencies, e.g. less than 1 megahertz.

Where in the foregoing description, integers or elements are mentioned which have known, obvious or foreseeable equivalents, then such equivalents are herein incorporated as if individually set forth. It will also be appreciated that integers or features of the present disclosure that are described as preferable, advantageous, convenient or the like are optional and do not limit the scope of the independent claims. Moreover, it is to be understood that such optional integers or features, whilst of possible benefit in some embodiments, may not be desirable, and may therefore be absent, in other embodiments.

The features of any dependent claim may be combined with the features of any of the independent claims or other dependent claims. Features described in relation to one example or embodiment may be used in other described examples or embodiments, e.g. by applying relevant portions of that disclosure.

1. A planar transformer for a direct current to direct current, DC/DC, converter, the planar transformer comprising:
a first portion; and
a second portion,
wherein each of the first and the second portion comprises a stacked structure comprising:
a first set of layers comprising first and second pairs of layers; and
a second set of layers comprising first and second pairs of layers,
wherein one of the first set and the second set is a set of primary winding layers, and the other one of the first set and the second set is a set of secondary winding layers,
wherein the second set is arranged between the first pair of layers of the first set and the second pair of layers of the first set, and
wherein each layer of the first and second sets is electrically isolated from every other layer of the first and second sets; and
wherein the first portion and the second portion are arranged such that a layer of the first set of layers of the first portion faces a layer of the first set of layers of the second portion across an air gap.

2. A planar transformer according to claim 1, wherein the first portion comprises a first printed circuit board, PCB, and the second portion comprises a second PCB.

3. A planar transformer according to claim 1, wherein the first portion and the second portion comprise an identical arrangement of layers to one another.

4. A planar transformer according to claim 1, wherein, for each of the first and second portions, the first set of layers and/or the second set of layers comprises a transposed layer formed of at least two segments of different conductors.

5. A planar transformer according to claim 1, wherein, for each of the first and second portions, each layer of the first set of layers and/or each layer of the second set of layers comprises a transposed layer formed of at least two segments of different conductors.

6. A planar transformer according to claim 1, wherein, for each of the first and second portions:
the first set of layers is the set of primary winding layers;
the second set of layers is the set of secondary winding layers;
each layer of the second set of layers comprises a transposed layer formed of at least two segments of different conductors; and
the first set of layers does not comprise a transposed layer formed of at least two segments of different conductors.

7. A planar transformer according to claim 4, wherein the or each transposed layer comprises a planar Litz structure.

8. A planar transformer according to claim 1, wherein each of the first and second portions comprises a first primary winding and a second primary winding connected in parallel to the first primary winding, each of the first and second primary windings comprising a respective plurality of layers of the set of primary winding layers.

9. A planar transformer according to claim 8, wherein, for each of the first and second portions, layers of the first primary winding are interleaved with layers of the second primary winding.

10. A planar transformer according to claim 1, wherein, for each of the first and second portions, at least some of the primary layers in the set of primary layers are connected to one another in series.

11. A planar transformer according to claim 1, wherein, for each of the first and second portions, at least some of the secondary layers in the set of secondary layers are connected to one another in parallel.

12. A planar transformer according to claim 1, wherein a layer of the first set of layers of the first portion is connected to a layer of the first set of layers of the second portion.

13. A planar transformer according to claim 1, wherein the planar transformer is configured to operate with a switching frequency of at least 1 megahertz.

14. A planar electrical transformer comprising:
a first printed circuit board, PCB; and
a second PCB,
wherein each of the first PCB and the second PCB comprises a stacked structure comprising:
first and second pairs of primary layers; and
first and second pairs of secondary layers, wherein the first and second pairs of secondary layers are arranged between the first pair of primary layers and the second pair of primary layers, and
wherein the first PCB and the second PCB are arranged such that a primary layer of the first PCB faces a primary layer of the second PCB across an air gap.

15. A method of manufacturing a planar electrical transformer for a direct current to direct current, DC/DC, converter, the method comprising:
providing a first stacked structure and a second stacked structure, each of the first and second stacked structures comprising:
a first set of layers comprising first and second pairs of layers; and
a second set of layers comprising first and second pairs of layers,
wherein one of the first set and the second set is a set of primary winding layers, and the other one of the first set and the second set is a set of secondary winding layers,
wherein the second set is arranged between the first pair of layers of the first set and the second pair of layers of the first set, and
wherein each layer of the first and second sets is electrically isolated from every other layer of the first and second sets; and
arranging the first and second stacked structures such that a layer of the first set of layers of the first stacked structure faces a layer of the first set of layers of the second stacked structure across an air gap.
